(19) United States
(12) Patent Application Publication
(10) Pub. No.: US 2010/0006684 A1
(43) Pub. Date: Jan. 14, 2010

(54) Spiral shear wood cutter

(76) Inventor: Robert Edward Burton, Willits, CA (US)

Correspondence Address: ROBERT E BURTON, 222 FRANKLIN AVE., WILLITS, CA, 95490, US

(21) Appl. No.: 12/218,109

(22) Filed: Jul. 10, 2008

(51) Int. Cl. B02C 13/02

(52) U.S. Cl. 241/239; 241/221

(57) ABSTRACT

A rotating browse food producing apparatus intended to produce edible feed stock for ruminants. The present invention incorporates a pair of spiral cutting blades mounted to a rotary machine that drives the cutting blades in a parallel axis located above a fixed reaction surface. Tree branch material is forced between the cutting blades traversing through an arc and a fixed reaction surface. The length of the spiral blades are configured to sever a fixed length portion of the cellulose feed stock to render a product suitable for animal feed.

### FIELD OF THE INVENTION

The present invention relates generally to machines that dedensify wood and other biomass into easily transportable segments. The invention specifically relates to—but is a unique and novel improvement on—wood chippers and chainsaws.

### BACKGROUND OF THE INVENTION

On-site tree limb processing generally requires gasoline or diesel powered cutting equipment that can be transported into dense forest environments of varying topographies. This equipment is dangerous, noisy, and requires constant maintenance.

Animal such as horses, cattle, goats, deer, and other ruminants graze on pastureland and woodland grasses as long as they are available. When this food stock has run out, these ruminants shift their feeding attention to the bark, leaves, and twigs of accessible brush—since all ruminants have the ability to turn cellulose into glucose. This food stock is considered browse food.

It is difficult to use common wood processing equipment to produce browse food. There is a need for tools that are extremely portable and energy efficient to process and prepare densely vegetated forest fuels to be properly sized for use in these applications. The present invention can be powered by any motive source, is an order of magnitude more efficient than prior art, and renders a wood product that is ideally sized to be used as a browse food for ruminants.

The closest prior art to the present invention includes Dupuis' U.S. Pat. No. 7,316,188, which discloses a very complex dedensification and delivery unit for the conversion of a wood source; Jonkka's U.S. Pat. No. 7,293,730, which is a knife fixing method wherein an external force is applied to a roller chain that drives multiple knife elements to process wood into sections; and Olofsson's U.S. Pat. No. 7,267,146 that describes an improved bed knife for a wood chipper. The present invention is a unique and novel improvement over all the referenced prior art.

### SUMMARY OF THE PRESENT INVENTION

A primary objective of the present invention is to provide a waste free browse food processing apparatus wherein cellulose tree branch material being fed into the machine is easy to hold, and doesn't pull or twist, both the machine and blade are very easy to manufacture and maintain, the machine is quiet and only requires minor adjustments, and the machine will operate at low speeds to be safer than high speed wood dedensification machines.

Another objective of the present invention is to provide a means to help solve the problem of uncontrollable wildfires caused by excessive buildup of small diameter slash and brush.

Another objective of the present invention is to provide a means to help meet the need for development of renewable energy through livestock feed augmentation through usage of previously unused cellulose feedstock, which will help in the effort to halt and reverse global climate change.

Another objective of the present invention is to allow fuller utilization of smaller branches than a chainsaw can safely cut, and replace chainsaws for repetitive cuts on branches once they are removed from a tree trunk.

The present invention provides the aforementioned benefits by incorporating a pair of spiral cutting blades mounted to a rotary machine that drives the cutting blades in a parallel axis located above a fixed reaction surface. The present invention discloses a device wherein tree branch material is forced between the cutting surfaces that traverse an expanding arc across a fixed reaction surface. The length of the spiral blades are configured to sever a fixed length portion of the cellulose feed stock to render a product suitable for animal feed.

As a piece of tree branch is being cut by the present invention, it can not turn or kick back while the cut is being made—and it self feeds into the machine at a very moderate rate. This feature greatly increases the operators' safety and comfort.

The rotary machine component of the present invention can be driven electrically, hydraulically, pneumatically, by a fossil fuel powered engine, or any other motive force—but the efficiency of the spiral knife design dramatically reduces the energy required to dedensify tree limbs and other biomass.

The present invention cuts tree limbs to a predetermined length based on the width and height of the spiral cutting blades, and the speed of rotation of the rotary drive machine. The slicing cut creates no sawdust, wood chips, or any other waste product.

### BRIEF DESCRIPTION OF THE DRAWINGS

FIG. 1 is a side view representation of the present invention.

FIG. 2 is a top view representation of the present invention.

FIG. 3 is an isometric view representation of the present invention.

FIG. 4 is an end view representation of the adjustable cutting bed of the present invention.

### DETAILED DESCRIPTION OF THE INVENTION

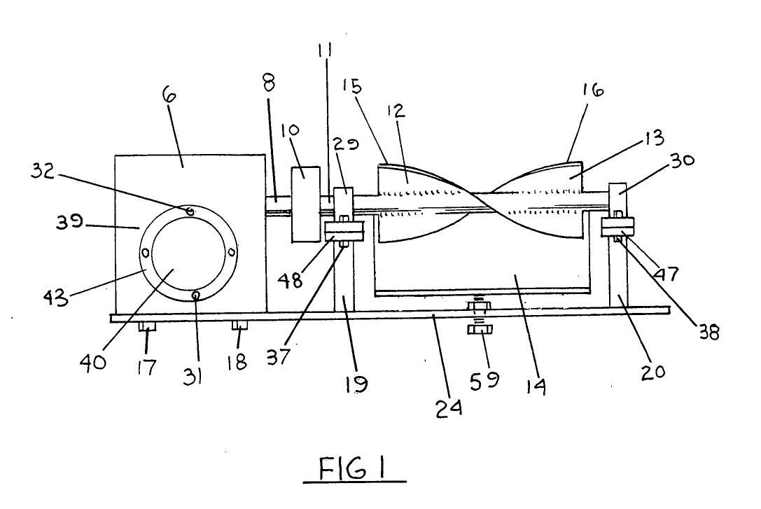

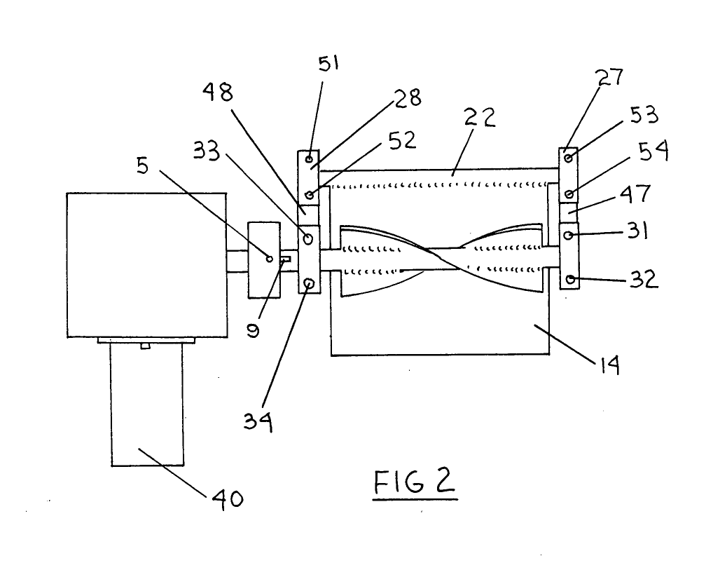

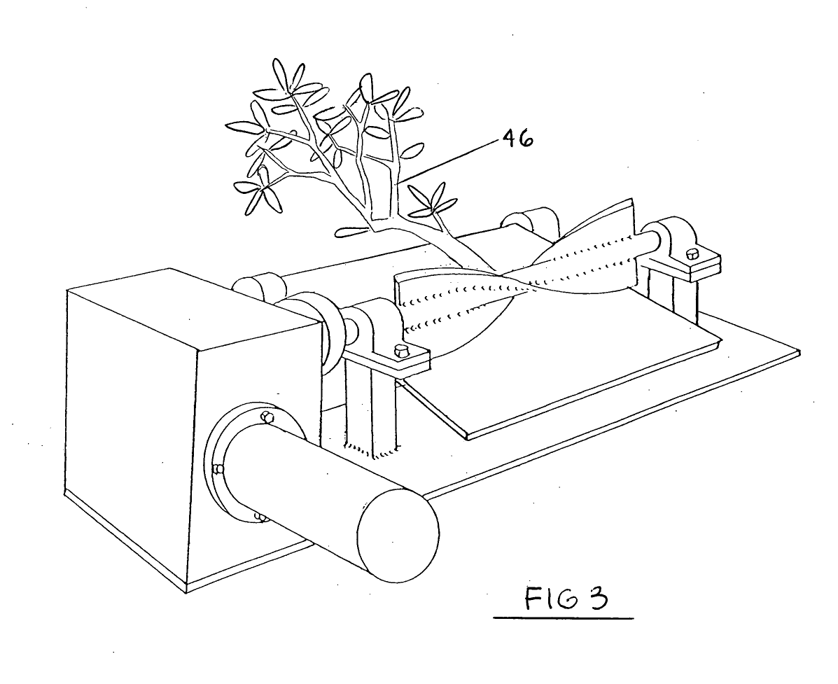

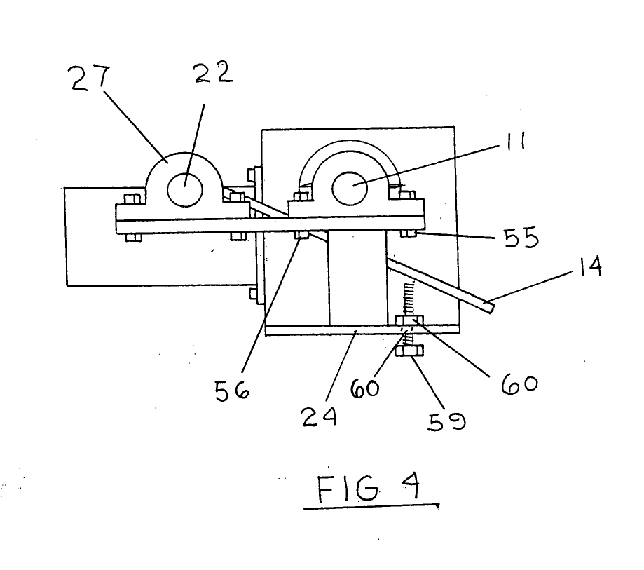

The preferred embodiment of the present invention, as presented in the side view in FIG. 1, the top view in FIG. 2, the isometric view in FIG. 3, and the end view detail in FIG. 4, incorporates a spiral shear assembly that slightly resembles the spiral reel in an old fashioned lawnmower. The spiral shear component of the present invention consists of two twelve inch by one and one half inch cutting blades 12 and 13 which are bent into a 180 degree spiral. The cutting edges 15 and 16 of said cutting blades 12 and 13 are tapered and sharpened. Cutting blades 12 and 13 are welded or fixedly attached around the circumference of round shaft 11, and configured equidistant from, and opposite each other.

Pillow blocks 29 and 30 are fitted to shaft 11 on either side of the horizontal ends of cutting blades 12 and 13. Horizontal mounting plates 47 and 48 are welded or otherwise fixedly attached to the upper surfaces of vertical mounting towers 19 and 20. Said vertical mounting towers 19 and 20 are made of a material that can be welded or otherwise fixedly attached to the upper surface of mounting plate 24. Pillow blocks 29 and 30 are secured to horizontal mounting plates 47 and 48 with bolts 31, 32, 33, and 34 and nuts 35, 36, 37, and 38.

Right angle gearbox 6 is solidly mounted to a flat mounting plate 24 with bolts 17 and 18 such that the gearbox 6 output shaft 8 is parallel to the long axis of mounting plate 24. Mounting plate 24 may be any rigid material that can be bolted and/or welded to.

One end of said shaft 11 is removably but solidly coupled to the output shaft 8 of right angle gearbox 6 with flexible shaft coupler 10, essentially extending said output shaft 8, and shaft coupler 10 is secured to shaft 11 with keyway 9 and setscrew 5. Said shaft coupler 10 is an industry standard device and needs no further description. Additionally, shaft coupler 10 is attached to shaft 11 at a height relative to mounting plate 24 and pivotable cutting bed 14 such that the cutting edges 15 and 16 of blades 12 and 13 slide by cutting bed 14 at a distance of approximately one thirty second of an inch at their closest point of contact as shaft 11 is rotated in a clockwise direction by gearbox 6, which is driven by motor 40.

Motor 40 may be an industry standard DC or AC electric motor; a gasoline of other fuel powered engine, a hydraulic motor, a pneumatic motor, or any other prime mover capable of outputting rotational force, and as such does not need to be detailed further herein, however, it is important that motor 40 be of a type that can reverse direction to release any jammed feed stock. Motor 40 is mounted to the input side 28 of gearbox 6 with bolts 31 and 32. Gearbox 6 is an industry standard right angle reduction gearbox and as such does not need further detail herein.

The motor 40 engages the gearbox 6 and provides rotational force to gearbox 6. Gearbox 6 ideally incorporates an industry standard face mount surface 43 to allow attachment of any suitable motor 40 capable of outputting the required torque to force the cutting edges 15 and 16 cutting edges of blades 12 and 13 through any tree limb branch 46 to completely sever a section of said branch 46.

As detailed in FIG. 4, cutting bed 14 may also be any flat surfaced rigid material that may be welded or otherwise fixedly attached to round adjusting shaft 22 at its upper long end. Pillow blocks 27 and 28 are fitted to both ends of adjusting shaft 22, and are fixedly attached to horizontal mounting plates 47 and 48 with bolts 51, 52, 53, and 54 and nuts 55, 56, 57, and 58 such that round adjusting shaft 22 and round shaft 11 are parallel to each other and that cutting bed 14 passes under blades 12 and 13. Adjusting screw 59 is attached to mounting plate 24 through a hole 61 and held in place with lock nut 60 such that said adjusting screw 59 can raise or lower cutting bed 14 to the proper functional height.

The present invention is intended to be operated such that as blades 12 and 13 are rotated slowly—nominally 50 rpm—around a substantially horizontal axis, a small round tree branch 46 is fed into the space between the spiral cutting edges 15 and 16 and the cutting bed 14. Any vertical movement of the branch 46 is stopped by the vertical reactive force of the cutting bed 14. The horizontal movement caused by the spiral shape of the cutting edges 15 and 16 is resisted by friction—the horizontal reactive force—between the tree branch 46 to be cut and the cutting bed 14. If said friction is not adequate to sustain the horizontal reactive force, the friction can be increased by incorporating rough or channeled surfaces in the path of horizontal movement on the upper surface of cutting bed 14.

A tree branch 46 up to one and one quarter inches in diameter can be fed under a descending blade 12 or 13, and the resulting downward force against said branch 46 is resisted by the reactive force of the cutting bed 14. The spiral shape of the blades 12 and 13 create a horizontal force which is resisted by the frictional reactive force between the branch 46 and the cutting bed 14. As the first of blades 12 and 13 completes its cut, the second blade of blades 12 and 13 begins its cut three to four inches back from the first cut on the branch 46, The result is a smooth, quiet, efficient slicing action that uses only a fraction of the power that typical 1700 rpm wood chippers and shredders in prior art use—resulting in a waste-free browse food producing apparatus.

Wood chippers and bush hogs both draw in the wood automatically, rapidly and forcefully—often presenting a danger to an operator. The present invention allows an operator to stop the forward feed action by simply pulling back on a branch 46 being fed into the machine. There is a short moment when the first of blades 12 and 13 completes its cut, and before the second of blades 12 and 13 starts its cut—when the branch 46 can be pulled back to stop the feed action.

While exemplary embodiments of the foregoing invention have been set forth for purposes of illustration, the foregoing description should not be deemed a limitation of the invention disclosed herein. Accordingly, various modifications, adaptations and alternatives may occur to one skilled in the art without departing from the spirit and the scope of the present invention.

1-6. (canceled)

7. A rotating browse food producing apparatus including in combination:
A pair of 180 degree spiral cutting blades mounted to a round shaft;
Said round shaft being supported at either end by a pair of pillow blocks;
Said round shaft coupled to a gearbox output shaft by a shaft coupler,
Said gearbox being driven by a machine capable of rotary motion;
A cutting bed providing a reaction force in opposition to said spiral cutting blades; And a mounting plate supporting said gearbox and said pillow blocks supporting said round shaft.

8. A rotating browse food producing apparatus according to claim 1 where said force producing machine is an electric motor.

9. A rotating browse food producing apparatus according to claim 1 where said force producing machine is a gasoline engine.

10. A rotating browse food producing apparatus according to claim 1 where said force producing machine is a diesel engine.

11. A rotating browse food producing apparatus according to claim 1 where said cutting bed is adjustable.

12. A rotating browse food producing apparatus according to claim 1 where said force producing machine is reversible.
